(19) United States
(12) Patent Application Publication
(10) Pub. No.: US 2020/0090092 A1
(43) Pub. Date: Mar. 19, 2020

(54) SYSTEM FOR SECURE REMOTE STAGING, PRE-PROCESSING, AND SETTLEMENT OF RESOURCE DISTRIBUTION DEVICES

(71) Applicant: BANK OF AMERICA CORPORATION, Charlotte, NC (US)

(72) Inventors: Kerry Michelle Cantley, Fort Mill, SC (US); Gary L. Best, JR., Acworth, GA (US); Coty Tyler Cherrix, Atlanta, GA (US)

(73) Assignee: BANK OF AMERICA CORPORATION, Charlotte, NC (US)

(21) Appl. No.: 16/130,133

(22) Filed: Sep. 13, 2018

(51) Int. Cl. G06Q 10/06; G06Q 10/08; G08G 1/00

(52) U.S. Cl. CPC G06Q 10/06315; G08G 1/202; G06Q 10/08

(57) ABSTRACT

Embodiments of the present invention provide a system for secure remote staging, pre-processing, and settlement of resource distribution devices. The present invention is configured to route a resource distribution vehicle to a resource distribution device, continuously monitor a real-time location of the resource distribution vehicle, identify that the real-time location of the resource distribution vehicle is within a predetermined distance from the resource distribution device based on continuously monitoring the real-time location of the resource distribution vehicle, establishing a secure communication channel with the resource distribution device and a user device of a user in a resource delivery vehicle, pre-processing the resource distribution device via the secure communication channel, identify that the real-time location of the resource distribution vehicle matches a first location of the resource distribution device, and display a message on a display screen of the resource distribution device.

### BACKGROUND

Present conventional systems do not have the capability to allow a user to pre-process distribution of resources associated with resource distribution devices before a resource distribution vehicle reaches the resource distribution devices. Moreover, the present conventional system also do not have the capability to allow the user to complete the process of settlement of resources associated with the resource distribution devices from the resource distribution vehicle, thereby increasing the down-time of the resource distribution devices and reducing the processing efficiency of the resource distribution devices. As such, there exists a need for a system to perform remote staging of resource distribution devices to facilitate pre-processing and settlement of the resource distribution devices.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing a holistic and secure resource provisioning gateway. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention routes a resource distribution vehicle to a first resource distribution device, continuously monitors a real-time location of the resource distribution vehicle, identifies that the real-time location of the resource distribution vehicle is within a predetermined distance from the first resource distribution device based on continuously monitoring the real-time location of the resource distribution vehicle, establishes a secure communication channel with the first resource distribution device and a user device, wherein the user device is associated with a user in a resource delivery vehicle associated with distribution of resources, pre-processes the first resource distribution device via the secure communication channel based on identifying that the real-time location of the resource distribution vehicle is within the predetermined distance from the first resource distribution device, identifies that the real-time location of the resource distribution vehicle matches a first location of the first resource distribution device, and in response to identifying that the real-time location of the resource distribution vehicle matches the first location of the first resource distribution device, display a message on a display screen of the first resource distribution device.

In some embodiments, the present invention determines that resource distribution associated with the first resource distribution device is complete, wherein the resource distribution is performed by the user using resources in the resource distribution vehicle and mirrors the display screen of the resource distribution device onto the user device via the secure communication channel.

In some embodiments, the present invention causes the message on the display screen of the first resource distribution device to disappear based on determining that the resource distribution associated with the first resource distribution device is complete.

In some embodiments, the present invention receives an input from the user device of the user via the mirrored display screen of the first resource distribution device, wherein the input is associated with settlement of the first resource distribution device, in response to receiving the input, causes the resource distribution device to initiate the settlement of the first resource distribution device via the secure communication channel.

In some embodiments, the present invention determines that the settlement of the first resource distribution device is complete via the secure communication channel and displays a notification associated with the completion of the settlement of the first resource distribution device on the user device.

In some embodiments, the present invention in response to determining that the settlement of the first resource distribution device is complete, routes the resource distribution vehicle to a second resource distribution device.

In some embodiments, the present invention monitors the one or more resource distribution devices, identifies a low resource level at the first resource distribution device of the one or more resource distribution devices, and in response to identifying the low resource level at the first resource distribution device, routes the resource distribution vehicle to the first resource distribution device.

In some embodiments, the present invention optimizes a travel route of the resource delivery vehicle.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for detecting unauthorized access via card characteristic verification, in accordance with an embodiment of the invention;

FIG. 2 provides a block diagram illustrating the entity system 200 of FIG. 1, in accordance with an embodiment of the invention;

FIG. 3 provides a block diagram illustrating a remote staging and pre-processing system 300 of FIG. 1, in accordance with an embodiment of the invention;

FIG. 4 provides a block diagram illustrating a resource distribution device 400 of FIG. 1, in accordance with an embodiment of the present invention;

FIG. 5 provides a block diagram for a plurality of computing systems 500 of FIG. 1, in accordance with an embodiment of the present invention;

FIG. 6A provides a flowchart illustrating a process flow for remote staging, pre-processing, and settlement of resource distribution devices, in accordance with an embodiment of the invention; and

FIG. 6B provides a flowchart illustrating a continuation of the process flow for remote staging, pre-processing, and settlement of resource distribution devices, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “entity” or “resource entity” may be any institution which involves in distribution of resources such as financial transactions. In one embodiment, the term “entity” or “resource entity” may be any financial institution. As used herein, the term “resource distribution device” described herein may be any devices or financial instruments that are involved in distribution of resources such as cash, checks, electronic transfers, assets, goods, services, vouchers, money orders or the like which may be performed using a resource distribution card (e.g., credit card, debit card, membership card, or the like). In some embodiments, the resource distribution device may be owned or maintained by a financial entity. In some embodiments, the resource distribution devices may be owned or maintained by a third party entity. In some embodiments of the present invention, the resource distribution device may be an Automated Teller Machine (ATM). In some embodiments of the present invention, the resource distribution device may be a POS device at a third party entity location.

As used herein, the term “third party entity” may be any merchant who is a customer of the entity. In some embodiments, the resource entity may be a customer of the third party entity. For example, the third party entity may be a vault management entity which delivers resources form the vault to multiple resource distribution services and collects money from multiple resource distribution devices and other third party entity locations to deliver it back to the vault. As used herein, the term “resource delivery vehicle” may be any armored truck which is maintained by a third party entity. In some embodiment, the resource delivery vehicle may be maintained by the resource entity directly. As described herein, the term “user” may be an employee of the entity.

Typically, the process of distribution of resources involves a user of the resource shutting down a resource distribution device for loading resources, picking up resources, processing of resources, and settlement of resources. This causes inconvenience to the customers of the entity and also decreases the efficiency of distribution of resources. Therefore, there exists a need for a system to efficiently complete the distribution of resources. The system of the present invention allows the user to perform pre-processing and post processing from a resource delivery vehicle without having to shut down the resources distribution device, thereby reducing the down-time of resource distribution devices.

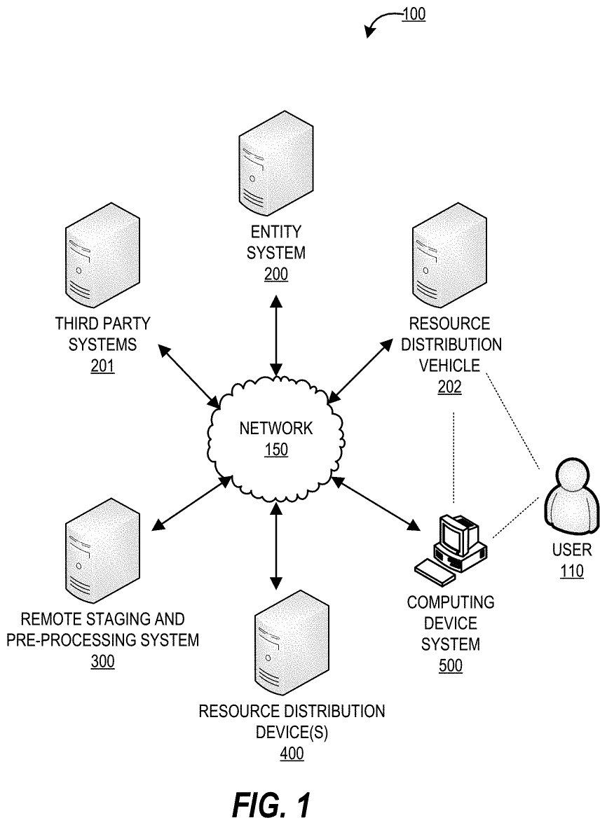

FIG. 1 provides a block diagram illustrating a system environment 100 for detecting unauthorized access via card characteristic verification, in accordance with an embodiment of the invention. As illustrated in FIG. 1, the environment 100 includes a remote staging and pre-processing system 300, resource distribution devices 400, entity system 200, one or more third party systems 201, and one or more resource distribution vehicles 202. In some embodiments, the resource distribution devices 400 may be operated, maintained, and/or controlled by the remote staging and pre-processing system 300. In some embodiments, the resource distribution devices 400 may be operated, maintained, and/or controlled by the entity systems 200. In some embodiments, the resource distribution devices 400 may be operated, maintained, and/or controlled by both the remote staging and pre-processing system 300 and the entity system 300. In some embodiments, the one or more resource distribution vehicles 202 may be operated, maintained, and/or controlled by the third party entity systems 201. In some other embodiments, the one or more resource distribution vehicles 202 may be operated, maintained, and/or controlled by the entity system 200. One or more users 110 may be included in the system environment 100, where the users 110 interact with the other entities of the system environment 100 via a user interface of the computing device system 400. The one or more users 110 may be any user in the resource distribution vehicle 202. For example, the user 100 may be a driver of the resource distribution vehicle 202.

In some embodiments, the remote staging and pre-processing system 300 may be a part of the entity system. In such an embodiment, the remote staging and pre-processing system 300 may transmit control signals remotely to the resource distribution device 400 to perform one or more actions and the computing devices 400 described herein. In some embodiments, the remote staging and pre-processing system 300 may be a remote and independent system which interacts with other systems in the system environment to perform one or more steps described herein. In such an embodiment, the system remotely communicates and/or manages the resource distribution vehicle 202, resource distribution devices 400, and/or computing device systems 400. In some embodiments, the remote staging and pre-processing system 300 may be a part of the resource delivery vehicle 202, the resource distribution device 400, or the computing device system 400.

The entity system(s) 200 may be any system owned or otherwise controlled by an entity to support or perform one or more process steps described herein. The entity may be any entity which is involved in financial transactions. In some embodiments, the entity is a financial institution. The remote staging and pre-processing system 300 and the resource distribution device 400 communicate with entity system 200 to perform one or more steps described herein.

The remote staging and pre-processing system 300, the entity system 200, the resource distribution device 400, the third party system 201, the computing device system 400, and/or the resource distribution vehicle 202 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

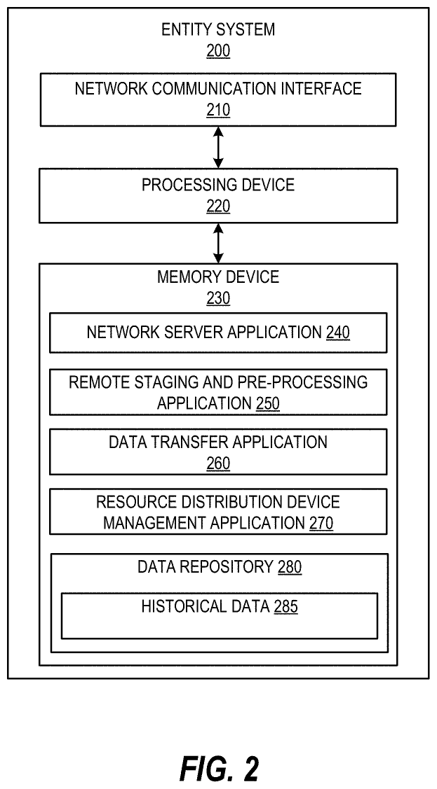

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a remote staging and pre-processing application 250, a data transfer application 260, a resource distribution device management application 270, and a data repository 280 comprising historical data 285. The historical data 285 may be any transactions related historical data. The computer-executable program code of the network server application 240, the remote staging and pre-processing application 250, the data transfer application 260, the resource distribution device management application 270 may instruct the processing device 220 to perform certain logic, data-extraction, and data-storing functions of the entity system 200 described herein, as well as communication functions of the entity system 200.

The network server application 240, the remote staging and pre-processing application 250, the data transfer application 260, the resource distribution device management application 270 are configured to store data in the data repository 280 or to use the data stored in the data repository 280 when communicating through the network communication interface 210 with the remote staging and pre-processing system 300, the resource distribution device 400, and the resource distribution vehicle 202 to perform one or more process steps described herein. In some embodiments, the entity system 200 may receive instructions from the remote staging and pre-processing system 300 via the remote staging and pre-processing application 250 to perform certain data transfer operations to the resource distribution vehicle 202 and/or the resource distribution device 400. Upon receiving the instructions from the remote staging and pre-processing system 300, the entity system 200 transfers data via the data transfer application 260.

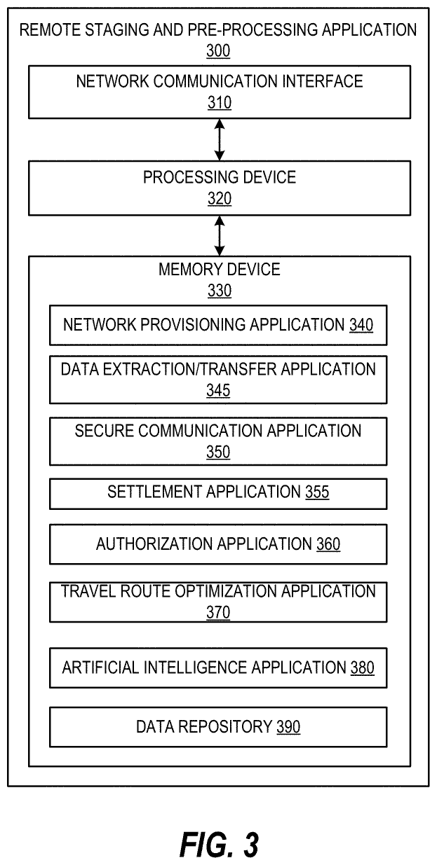

FIG. 3 provides a block diagram illustrating the remote staging and pre-processing system 300 in greater detail, in accordance with embodiments of the invention. As mentioned above, the remote staging and pre-processing system 300 of FIG. 1 is configured to perform the one or more functions described herein.

As illustrated in FIG. 3, in one embodiment of the invention, the remote staging and pre-processing system 300 includes one or more processing devices 320 operatively coupled to a network communication interface 310 and a memory device 330. In certain embodiments, the remote staging and pre-processing system 300 is operated by a first entity, such as a financial institution, while in other embodiments, the remote staging and pre-processing system 300 is operated by an entity other than a financial institution. In some embodiments, the remote staging and pre-processing system 300 may be an independent system. In alternate embodiments, the remote staging and pre-processing system 300 may be a part of the entity system 200 or the resource distribution device 400.

It should be understood that the memory device 330 may include one or more databases or other data structures/repositories. The memory device 330 also includes computer-executable program code that instructs the processing device 320 to operate the network communication interface 310 to perform certain communication functions of the remote staging and pre-processing system 300 described herein. For example, in one embodiment of the remote staging and pre-processing system 300, the memory device 330 includes, but is not limited to, a network server application 340, a data extraction/transfer application 345, a secure communication application 350, a settlement application 355, an authorization application 360, a travel route optimization application 370, an artificial intelligence application 380, and a data repository 390. The computer-executable program code of the network server application 340, the data extraction/transfer application 345, the secure communication application 350, the settlement application 355, the authorization application 360, the travel route optimization application 370, and the artificial intelligence application 380, may instruct the processing device 320 to perform certain logic, data-processing, and data-storing functions of the remote staging and pre-processing system 300 described herein, as well as communication functions of the remote staging and pre-processing system 300.

In some embodiments, the network server application 340, the data extraction/transfer application 345, the secure communication application 350, the settlement application 355, the authorization application 360, the travel route optimization application 370, and the artificial intelligence application 380 may be a part of single application. The network provisioning application 340 may allow the remote staging and pre-processing system 300 to communicate with the resource distribution device 400, resource delivery vehicle 202, entity system 200, and other third party entity systems 201 to authorize resource distribution events and also to perform remote staging, pre-processing, and settlement of resource distribution devices 400. The data extraction/transfer application 345 may extract data from data repository 280 of entity system and may use the historical data 285 to intelligently route the resource distribution vehicles 202 via the artificial intelligence application 380. The secure communication application 355 allows the remote staging and pre-processing system 300 to establish a secure communication channel with the resource distribution devices 400, resource delivery vehicle 202, and/or the computing device systems 500. The settlement application 355 facilitates the settlement of the resource distribution devices 400. The authorization application 360 allows the user 110 to gain access to the user computing device system 500, the resource distribution device 300, and/or the resource distribution vehicle 202. The travel route optimization application 370 optimizes the travel route of the resource distribution vehicles 202 based on the historical data and by communicating with entity system 200 and other third party entity systems 300 in order to improve the efficiency of the resource delivery process.

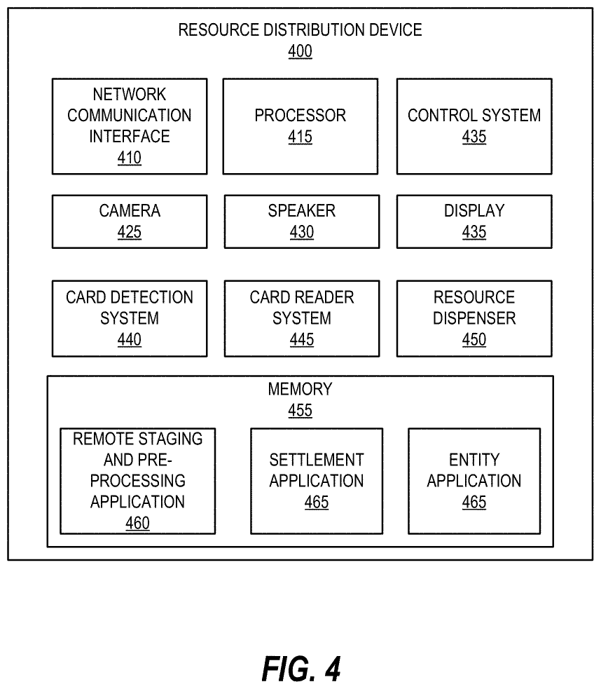

FIG. 4 provides a block diagram of the resource distribution device 400, in accordance with an embodiment of the present invention. As illustrated in FIG. 4, in one embodiment of the invention, the resource distribution device 400 includes a processor 415 operatively coupled to a network communication interface 410, a memory component 455, a control system 435, a camera 425, a speaker 430, a display 435, a card detection system 440, a card reader system 445, and a resource dispenser 450. The resource distribution device may include other components such as bar code scanner, resource counter, to perform multiple functions of the resource distribution devices 400.

It should be understood that the memory component 455 may include one or more databases or other data structures/repositories. The memory component 455 also includes computer-executable program code that instructs the processor 415 to operate the network communication interface 410 to perform certain communication functions of the resource distribution device 400 described herein and also instructs the processor 415 to cause the control system 435 to perform certain actions of the resource distribution device 400 including, but not limited to, dispensing resources, displaying messages on the display 435, performing resource count, or the like. In one embodiment, the memory component may include a remote staging and pre-processing application 460 provided by the remote staging and pre-processing system 300, an entity application 465 provided by the entity system 200, and a settlement application 465. In some embodiments, the memory component 455 may include only the remote staging and pre-processing application 460 which may allow the resource distribution device 400 to communicate with the entity system 200. Based on the instructions and control signals received from the remote staging and pre-processing system 300 via network communication interface and the remote staging and pre-processing application 460, the processor 415 via the control system 435 may operate the resource distribution device 400 such as displaying messages on the display 435, completing settlement process, or to perform certain other actions described herein.

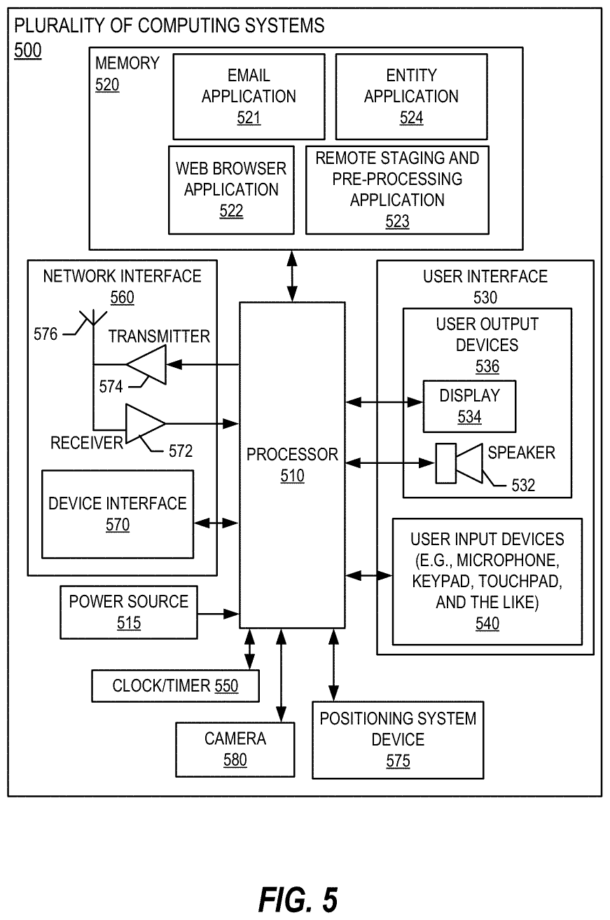

FIG. 5 provides a block diagram illustrating a plurality of computing systems 400 of FIG. 1 in more detail, in accordance with embodiments of the invention. The plurality of computing systems 500 are associated with the plurality of users 110. In one embodiment the plurality of users 110 may be an employee, contractor, or otherwise affiliated with the entity of the plurality of entity systems 200. However, it should be understood that a mobile telephone is merely illustrative of one type of plurality of computing systems 500 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the plurality of computing systems 500 include a processor 510 communicably coupled to such devices as a memory 420, user output devices 536, user input devices 540, a network interface 560, a power source 515, a clock or other timer 550, a camera 580, and a positioning system device 575. The processor 510, and other processors described herein, generally include circuitry for implementing communication and/or logic functions of the plurality of computing systems 500. For example, the processor 510 may include a digital signal processor device, a microprocessor device, and various analog to digital converters, digital to analog converters, and/or other support circuits. Control and signal processing functions of the plurality of computing systems 500 are allocated between these devices according to their respective capabilities. The processor 510 thus may also include the functionality to encode and interleave messages and data prior to modulation and transmission. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the plurality of computing systems 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 150. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. The signals may include signaling information in accordance with the air interface standard of the applicable cellular system of the network 150. In this regard, the plurality of computing systems 500 may be configured to operate with one or more air interface standards, communication protocols, modulation types, and access types. By way of illustration, the plurality of computing systems 500 may be configured to operate in accordance with any of a number of first, second, third, and/or fourth-generation communication protocols and/or the like. For example, the plurality of computing systems 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The plurality of computing systems 500 may also be configured to operate in accordance with non-cellular communication mechanisms, such as via a wireless local area network (WLAN) or other communication/data networks.

As described above, the plurality of computing systems 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510.

The user input devices 540, which allow the plurality of computing systems 500 to receive data from a plurality of users 110, may include any of a number of devices allowing the plurality of computing systems 500 to receive data from the plurality of users 110, such as a keypad, keyboard, touch-screen, touchpad, microphone, mouse, joystick, other pointer device, button, soft key, and/or other input device(s). The user interface may also include a camera 580, such as a digital camera.

The plurality of computing systems 500 may also include a positioning system device 575 that is configured to be used by a positioning system to determine a location of the plurality of computing systems 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate or exact geographical location of the plurality of computing systems 500. In other embodiments, the positioning system device 575 includes a proximity sensor or transmitter, such as an RFID tag, that can sense or be sensed by devices known to be located proximate a merchant or other location to determine that the plurality of computing systems 500 is located proximate these known devices.

The plurality of computing systems 500 further includes a power source 515, such as a battery, for powering various circuits and other devices that are used to operate the plurality of computing systems 500. Embodiments of the plurality of computing systems 500 may also include a clock or other timer 550 configured to determine and, in some cases, communicate actual or relative time to the processor 510 or one or more other devices.

The plurality of computing systems 500 also includes a memory 520 operatively coupled to the processor 510. As used herein, memory includes any computer readable medium (as defined herein below) configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the plurality of computing systems 500 and/or one or more of the process/method steps described herein. For example, the memory 520 may include such applications as a conventional web browser application 522, an email application 521, an entity application 524, a remote staging and pre-processing application 523, or the like. The email application 521, the web browser application 522, the remote staging and pre-processing application 523 may allow the plurality of users 110 to communicate with the plurality of entity systems 500, the remote staging and pre-processing system 300, resource distribution devices 500, resource distribution vehicle 202, and the third party server 201. The entity application 524 allows the one or more users 110 to interact with the plurality of entity systems 200. The remote staging and pre-processing application 523 may be present in the memory 520 of the plurality of computing systems 500 to allow direct communication with the remote staging and pre-processing system 300 and also the resource distribution devices 500.

The memory 520 can also store any of a number of pieces of information, and data, used by the plurality of computing systems 500 and the applications and devices that make up the plurality of computing systems 500 or are in communication with the plurality of computing systems 500 to implement the functions of the plurality of computing systems 500 and/or the other systems described herein.

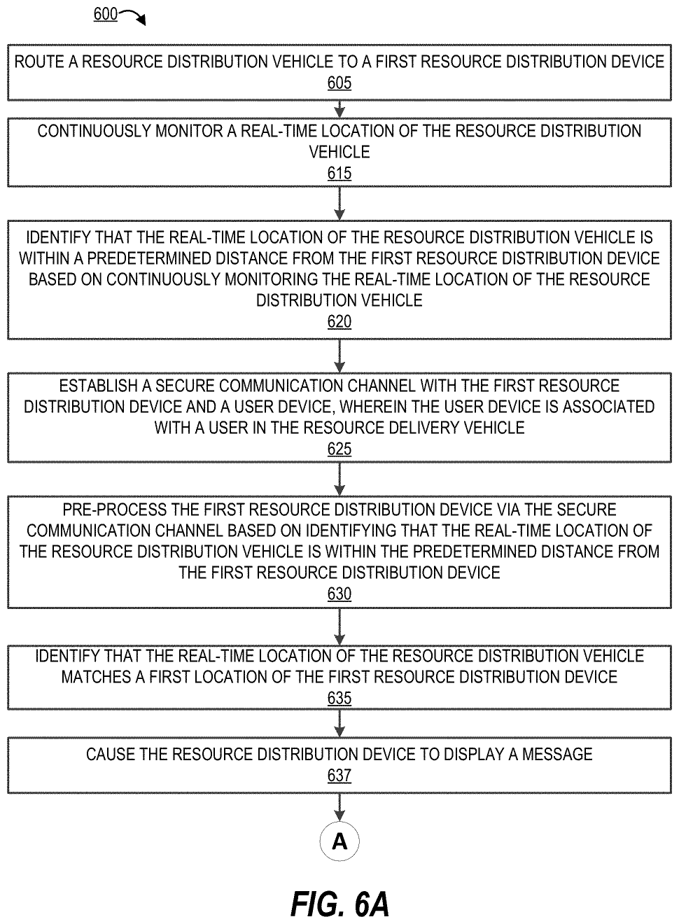

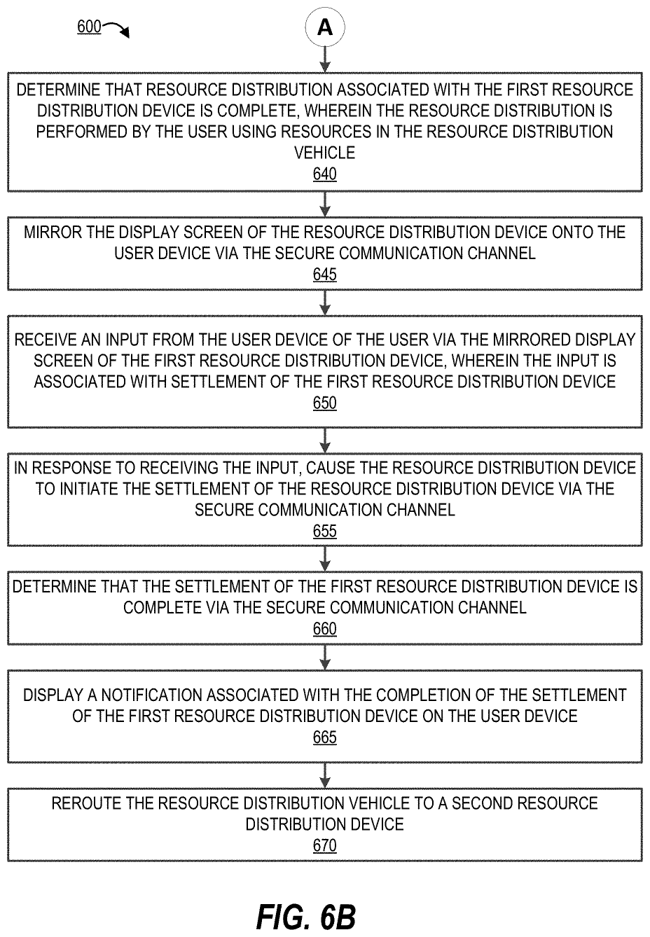

FIG. 6A and FIG. 6B provide a flowchart illustrating a process flow 600 for remote staging, pre-processing, and settlement of resource distribution devices, in accordance with an embodiment of the present invention. As shown in the block 605, the system routes a resource distribution vehicle to a first resource distribution device. The system may perform routing of the resource distribution vehicle based on one or more of historical transaction data associated with the resource distribution devices, current resource capacity, traffic conditions, or the like. In one embodiment, the system may determine that the first resource distribution currently has a low resource capacity and may route the resource distribution vehicle to the first resource distribution device. For example, the system may identify that a first ATM is running low on cash and may route the cash delivery truck to the first ATM. In another embodiment, the system may determine that the first resource distribution device is scheduled to receive resources on a specific day, identify that the user traffic is low during a time period on that day based on the historical transaction data of the first resource distribution device, and route the resource distribution vehicle to the first resource distribution device during that time period. For example, the system may identify that a first ATM is scheduled to received cash on a Wednesday and may identify that the first ATM has less user traffic between 3 PM and 4 PM and may route the cash delivery vehicle to the first ATM to perform the cash delivery at 3 PM. In some embodiments, the system may identify that the traffic along the travel route to the first resource distribution device is high between 8 AM and 10 AM and may route the resource distribution vehicle to the first resource distribution device after 10 AM.

As shown in block 615, the system continuously monitors a real-time location of the resource distribution vehicle. The system may monitor the real-time location of the resource distribution vehicle via a GPS device of the resource distribution vehicle. In other embodiments, the system may monitor the real-time location of the resource distribution vehicle via a GPS of a user device associated with a user travelling in the resource distribution vehicle. In some embodiments of the present invention, the user device may be an authorized device provided by the entity system or the third party entity system.

As shown in block 620, the system identifies that the real-time location of the resource distribution vehicle is within a predetermined distance from the first resource distribution device based on continuously monitoring the real-time location of the resource distribution vehicle. For example, the system may identify that the resource distribution vehicle is 3 miles away from the location of the first resource distribution device. In some embodiments, the predetermined distance may be calculate dynamically by the system based on multiple factors such as an estimate of the pre-processing time required based on a historical data associated with a number of transactions, the amount of resources that are being delivered, current traffic to each the first resource distribution device, speed limit along the travel route, and the like.

As shown in block 625, the system establishes a secure communication channel with the first resource distribution device and the user device. The secure communication channel may be any channel with added security. In one embodiment, the secure communication channel comprises one or more layers of encryption. In one embodiment, the secure communication channel may be through an application which is provided to the first resource distribution device and the user device. The system may establish the secure communication channel in response to identifying that the real-time location of the resource distribution vehicle is within the predetermined distance from the first resource distribution device.

As shown in block 630, the system pre-processes the first resource distribution device via the secure communication channel based on identifying that the real-time location of the resource distribution vehicle is within the predetermined distance from the first resource distribution device. Pre-processing may include any form of information that is to be entered into the first resource distribution device to complete the delivery of resources and also to settle multiple transactions associated with the first resource distribution device. In some embodiments, the system may mirror the display screen onto the user device and may allow the user to fill out the required information. In some embodiments, the system may automatically prefill the data and present it to the user for verification. In some embodiments, the system instead of mirroring the display screen onto the user device, may transfer the data associated with the pre-processing to the resource distribution device and may cause the resource distribution device to prefill the necessary fields in multiple forms or the like. In such an embodiment, the system may prompt the user on the user device to answer questions related to preprocessing via the application provided by the system. The system may then transfer the data received from the user back to the resource distribution device for pre-processing. After the completion of pre-processing, the system may display the data or screens associated with the preprocessing.

As shown in block 635, the system identifies that the real-time location of the resource distribution device matches a first location of the first resource distribution device based on continuously monitoring the real-time location of the resource distribution vehicle. For example, the system may identify that the cash delivery truck has reached the ATM location. As shown in block 637, the system in response to identifying that the real-time location of the resource distribution vehicle matches the first location of the first resource distribution device, cause the resource distribution device to display a message that the first resource distribution device is down for maintenance. The system may transmit control signals to the first resource distribution device which then cause the first resource distribution device to display the message.

As shown in block 640, the system determines that resource distribution associated with the first resource distribution device is complete, wherein the resource distribution is performed by the user using resources in the resource distribution vehicle. The user may load the resources into the first resource distribution device by scanning a barcode on the resources and inserting the resources into the resource distribution device, at which point the first resource distribution device performs the necessary calculations. In one embodiment, the first resource distribution device may transmit a signal to the system after determining that the calculations match the expected resource input. In some embodiments, the system may automatically determine that the resource distribution is complete and that the calculations match the expected resource input. For example, the system may determine that the loading of cash is complete based on counting the cash and determining that the count matches the expect input of cash into the first ATM. In some embodiments, in response to determining that the resource distribution associated with the first resource distribution device is complete, the system may cause the first resource distribution device to stop displaying the message discussed in block 637.

As shown in block 645, the system mirrors the display screen of the resource distribution device onto the user device via the secure communication channel. The system in response to determining that resource distribution associated with the first resource distribution device is complete, may mirror the display screen of the resource distribution device onto the user device. The mirrored display may allow the user to complete post-processing of resource distribution and completion of settlement from the resource distribution vehicle without having to wait at the resource distribution device. While mirroring the display screen onto the user device, the system causes the resource distribution device to perform parallel operation by causing the display screen of the resource distribution device to display options which allow a customer to perform transactions at the resource distribution device. This reduces the downtime of the resource distribution device.

As shown in block 650, the system receives an input from the user device of the user via the mirrored display screen of the first resource distribution device, wherein the input is associated with settlement of the first resource distribution device. The input may be associated with post-processing of the resource distribution or completion of settlement. As shown in block 655, the system in response to receiving the input, causes the resource distribution device to initiate the settlement of the resource distribution device via the secure communication channel. In some embodiments, the system may allow the user to initiate the settlement. In other embodiments, the system may automatically detect that the user provided the necessary information and authorization and may automatically cause the first resource distribution device to perform settlement of resources. In some embodiments, the system may communicate with entity system to provide necessary information associated with settlement of resources.

As shown in block 660, the system determines that the settlement of the first resource distribution device is complete via the secure communication channel. In some embodiments, the system may receive a notification from the first resource distribution device that the settlement of resources is complete. In some embodiments, the system may automatically identify that the settlement of resources is complete.

As shown in block 665, the system displays a notification associated with the completion of the settlement of the first resource distribution device on the user device. For example, the system after determining that the settlement of the first resource distribution device is complete, the system notifies the user by displaying a message on the user device via an application provided by the system. As shown in block 670, the system reroutes the resource distribution vehicle to a second resource distribution device. The system may have the ability to optimize the travel route of the resource delivery vehicle and improve the efficiency of the resource distribution process. The optimization may be based on historical data, user traffic at the resource distribution devices, resource level, resources in the resource distribution device, and the like. In one example, the system may identify that the resources in the resource delivery vehicle is below a predetermined limit and may route the resource delivery vehicle to a resource distribution device where resource pick-up is scheduled for the day. This reduces the travel time to a resource vault and thereby increases the efficiency of the resource distribution process.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for secure remote staging, pre-processing, and settlement of resource distribution devices, the system comprising:
at least one transitory storage device; and
at least one processing device coupled to the at least one non-transitory storage device, wherein the at least one processing device is configured to:
route a resource distribution vehicle to a first resource distribution device;
continuously monitor a real-time location of the resource distribution vehicle;
identify that the real-time location of the resource distribution vehicle is within a predetermined distance from the first resource distribution device based on continuously monitoring the real-time location of the resource distribution vehicle;
establish a secure communication channel with the first resource distribution device and a user device, wherein the user device is associated with a user in a resource delivery vehicle associated with distribution of resources;
pre-process the first resource distribution device via the secure communication channel based on identifying that the real-time location of the resource distribution vehicle is within the predetermined distance from the first resource distribution device;
identify that the real-time location of the resource distribution vehicle matches a first location of the first resource distribution device; and
in response to identifying that the real-time location of the resource distribution vehicle matches the first location of the first resource distribution device, display a message on a display screen of the first resource distribution device.

2. The system of claim 1, wherein the at least one processing device is further configured to:
determine that resource distribution associated with the first resource distribution device is complete, wherein the resource distribution is performed by the user using resources in the resource distribution vehicle; and
mirror the display screen of the resource distribution device onto the user device via the secure communication channel.

3. The system of claim 2, wherein the at least one processing device is further configured to cause the message on the display screen of the first resource distribution device to disappear based on determining that the resource distribution associated with the first resource distribution device is complete.

4. The system of claim 2, wherein the at least one processing device is configured to:
receive an input from the user device of the user via the mirrored display screen of the first resource distribution device, wherein the input is associated with settlement of the first resource distribution device;
in response to receiving the input, cause the resource distribution device to initiate the settlement of the first resource distribution device via the secure communication channel.

5. The system of claim 4, wherein the at least one processing device is configured to:
determine that the settlement of the first resource distribution device is complete via the secure communication channel; and
display a notification associated with the completion of the settlement of the first resource distribution device on the user device.

6. The system of claim 5, wherein the at least one processing device is configured to:
in response to determining that the settlement of the first resource distribution device is complete, route the resource distribution vehicle to a second resource distribution device.

7. The system of claim 1, wherein the at least one processing device is configured to route the resource distribution vehicle to the first resource distribution device by:
monitoring one or more resource distribution devices;
identify a low resource level at the first resource distribution device of the one or more resource distribution devices; and
in response to identifying the low resource level at the first resource distribution device, route the resource distribution vehicle to the first resource distribution device.

8. The system of claim 1, wherein the at least one processing device is configured to optimize a travel route of the resource delivery vehicle.

9. A computer program product for secure remote staging, pre-processing, and settlement of resource distribution devices, the computer program product comprising a non-transitory computer-readable storage medium having computer-executable instructions for causing a computer processor to perform the steps of:
routing a resource distribution vehicle to a first resource distribution device;
continuously monitoring a real-time location of the resource distribution vehicle;
identifying that the real-time location of the resource distribution vehicle is within a predetermined distance from the first resource distribution device based on continuously monitoring the real-time location of the resource distribution vehicle;
establishing a secure communication channel with the first resource distribution device and a user device, wherein the user device is associated with a user in a resource delivery vehicle associated with distribution of resources;
pre-processing the first resource distribution device via the secure communication channel based on identifying that the real-time location of the resource distribution vehicle is within the predetermined distance from the first resource distribution device;
identifying that the real-time location of the resource distribution vehicle matches a first location of the first resource distribution device; and
in response to identifying that the real-time location of the resource distribution vehicle matches the first location of the first resource distribution device, displaying a message on a display screen of the first resource distribution device.

10. The computer program product of claim 9, wherein the computer-executable instructions further cause the computer processor to perform the steps of:
determining that resource distribution associated with the first resource distribution device is complete, wherein the resource distribution is performed by the user using resources in the resource distribution vehicle; and
minoring the display screen of the resource distribution device onto the user device via the secure communication channel.

11. The computer program product of claim 10, wherein the computer-executable instructions further cause the computer processor to perform the step of causing the message on the display screen of the first resource distribution device to disappear based on determining that the resource distribution associated with the first resource distribution device is complete.

12. The computer program product of claim 10, wherein the computer-executable instructions further cause the computer processor to perform the steps of:
receiving an input from the user device of the user via the mirrored display screen of the first resource distribution device, wherein the input is associated with settlement of the first resource distribution device; and
in response to receiving the input, causing the resource distribution device to initiate the settlement of the first resource distribution device via the secure communication channel.

13. The computer program product of claim 12, wherein the computer-executable instructions further cause the computer processor to perform the steps of:
determining that the settlement of the first resource distribution device is complete via the secure communication channel; and
displaying a notification associated with the completion of the settlement of the first resource distribution device on the user device.

14. The computer program product of claim 13, wherein the computer-executable instructions further cause the computer processor to perform the step of in response to determining that the settlement of the first resource distribution device is complete, route the resource distribution vehicle to a second resource distribution device.

15. The computer program product of claim 9, wherein the computer-executable instructions further cause the computer processor to perform the steps of:
monitoring one or more resource distribution devices;
identify a low resource level at the first resource distribution device of the one or more resource distribution devices; and
in response to identifying the low resource level at the first resource distribution device, route the resource distribution vehicle to the first resource distribution device.

16. The computer program product of claim 9, wherein the computer-executable instructions further cause the computer processor to perform the step of optimizing a travel route of the resource delivery vehicle.

17. A computerized method for secure remote staging, pre-processing, and settlement of resource distribution devices, the method comprising:
routing a resource distribution vehicle to a first resource distribution device;
continuously monitoring a real-time location of the resource distribution vehicle;
identifying that the real-time location of the resource distribution vehicle is within a predetermined distance from the first resource distribution device based on continuously monitoring the real-time location of the resource distribution vehicle;
establishing a secure communication channel with the first resource distribution device and a user device, wherein the user device is associated with a user in a resource delivery vehicle associated with distribution of resources;
pre-processing the first resource distribution device via the secure communication channel based on identifying that the real-time location of the resource distribution vehicle is within the predetermined distance from the first resource distribution device;
identifying that the real-time location of the resource distribution vehicle matches a first location of the first resource distribution device; and
in response to identifying that the real-time location of the resource distribution vehicle matches the first location of the first resource distribution device, displaying a message on a display screen of the first resource distribution device.

18. The computerized method of claim 17, wherein the method further comprises:
determining that resource distribution associated with the first resource distribution device is complete, wherein the resource distribution is performed by the user using resources in the resource distribution vehicle; and
mirroring the display screen of the resource distribution device onto the user device via the secure communication channel.

19. The computerized method of claim 17, wherein the computerized method further comprises causing the message on the display screen of the first resource distribution device to disappear based on determining that the resource distribution associated with the first resource distribution device is complete.

20. The computerized method of claim 19, wherein the computerized method further comprises:
receive an input from the user device of the user via the mirrored display screen of the first resource distribution device, wherein the input is associated with settlement of the first resource distribution device;
in response to receiving the input, cause the resource distribution device to initiate the settlement of the first resource distribution device via the secure communication channel.
